(19) United States
(12) Patent Application Publication
(10) Pub. No.: US 2009/0301318 A1
(43) Pub. Date: Dec. 10, 2009

(54) AUTOMATIC MACHINE FOR CITRUS FRUIT JUICE EXTRACTION WITH FUNCTIONAL ELEMENTS ALLOWING EASIER CLEANING

(75) Inventors: Salvatora Torrisi, Catania (IT); Marcello Catalano, Catania (IT)

Correspondence Address: BANNER & WITCOFF, LTD., 1100 13th STREET, N.W., SUITE 1200, WASHINGTON, DC, 20005-4051, US

(73) Assignee: A.A.T. AGROINDUSTRY ADVANCED TECHNOLOGIES S.P.A., Cantania (IT)

(21) Appl. No.: 12/441,651

(22) PCT Filed: Sep. 19, 2007
(86) PCT No.: PCT/IT2007/000650

§ 371 Date: Aug. 4, 2009

(30) Foreign Application Priority Data
Sep. 19, 2006 (IT) BO2006A000640

(51) Int. Cl. A23N 1/00

(52) U.S. Cl. 99/503; 99/509

(57) ABSTRACT

An automatic machine (1) for citrus fruit juice extraction with functional elements allowing easier cleaning, which comprises a machine body (2) which contains a motor assembly and is provided with quick-coupling means for a front juice extraction chamber, which is constituted by a sort of tank (8) inside which an outer drum (23) is fitted so that it can rotate, a juice extraction and filtration drum (20) being fitted within the outer drum and being actuated rotatably concordantly with the outer drum at a short distance from its internal surface, the juice extraction and filtration drum having a reduced diameter and a perforated surface, with an axis which is aligned with an eccentric hole of the bottom of the tank for the passage of the motor shaft, means (24a, 24b, 25a, 25b) being provided for ressin the outer drum (23) elasticall a ainst the inner drum (20).

### TECHNICAL FIELD

The present invention relates to an automatic machine for citrus fruit juice extraction with functional elements allowing easier cleaning.

### BACKGROUND ART

Automatic machines for extracting citrus fruit juice on demand suffer drawbacks in relation to their technical complexity, to the large number of components that need to be washed often, and to the periodic maintenance which entails the rather complicated disassembly of several parts: one must in fact bear in mind that the sugary and oily organic substances that are deposited on the functional elements of the machine rapidly tend to degrade and attract fruit flies, wasps, bees and animals of various and unpleasant kinds, and this occurs particularly at high ambient temperatures, such as those in the seasons in which the machine according to the invention is used more usually.

### DISCLOSURE OF THE INVENTION

The aim of the present invention is to obviate the above-mentioned drawbacks of known devices, by providing an automatic machine for citrus fruit juice extraction with functional elements allowing easier cleaning which is extremely simple and can be disassembled easily and rapidly for periodic cleaning and for ordinary maintenance.

Within this aim, an object of the present invention is to provide an automatic machine with a structure which is simple, relatively easy to provide in practice, safe in use, effective in operation, and has a relatively low cost.

This aim and this object, as well as others which will become better apparent hereinafter, are achieved by the present automatic machine for citrus fruit juice extraction with functional elements allowing easier cleaning, characterized in that it comprises a footing which comprises a motor assembly and is provided with quick-coupling means for a front juice extraction chamber, which is constituted by a sort of tank inside which an outer drum is fitted so that it can rotate, a juice extraction and filtration drum being fitted within said outer drum and actuated rotatably concordantly with said outer drum at a short distance from its internal surface, said juice extraction and filtration drum having a reduced diameter and a perforated surface, with an axis which is aligned with an eccentric hole of the bottom of the tank for the passage of the motor shaft, means being provided for pressing said outer drum elastically against the inner drum.

### BRIEF DESCRIPTION OF THE DRAWINGS

Further characteristics and advantages of the invention will become better apparent from the following detailed description of a preferred but not exclusive embodiment of an automatic machine for citrus fruit juice extraction with functional elements allowing easier cleaning, according to the invention, illustrated by way of non-limiting example in the accompanying drawings, wherein:

FIG. 1 is a front perspective view of an automatic machine for citrus fruit juice extraction according to the invention;

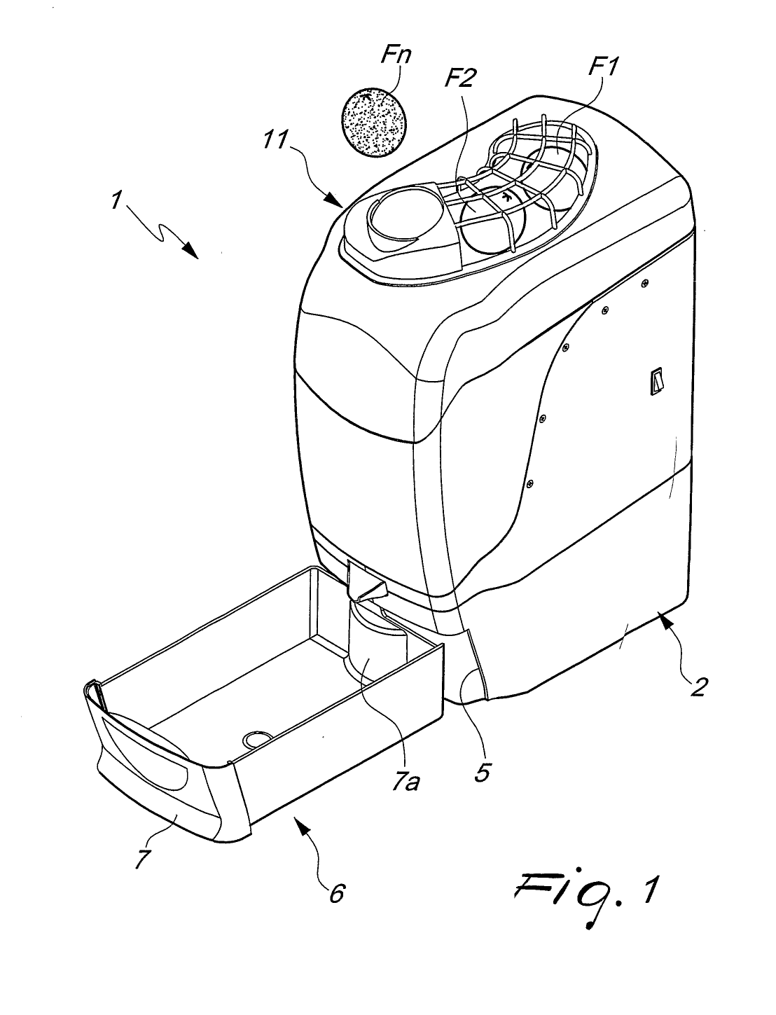

FIG. 2 is a perspective view of the transparent upper lid;

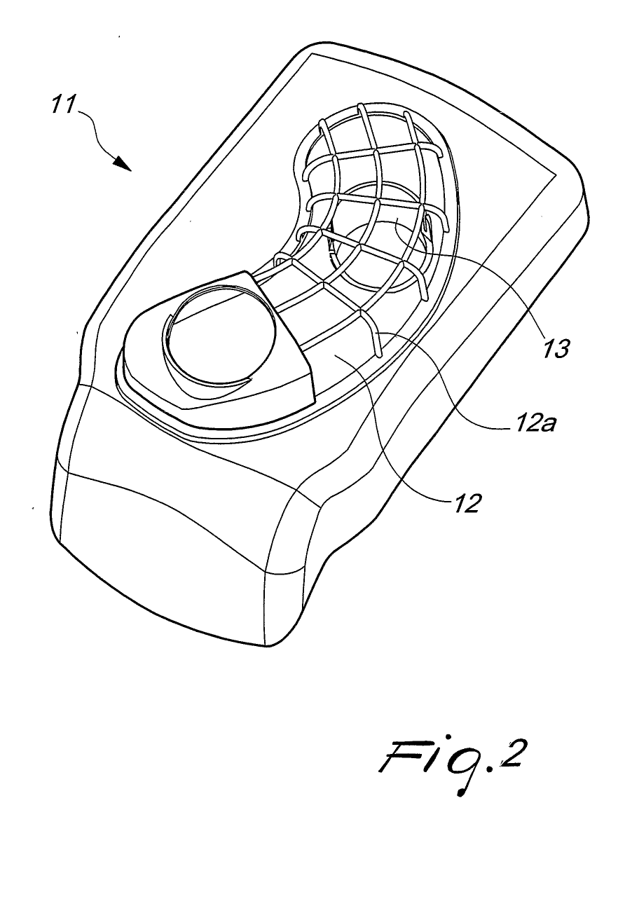

FIG. 3 is a rear perspective view of the automatic machine for citrus fruit juice extraction according to the invention;

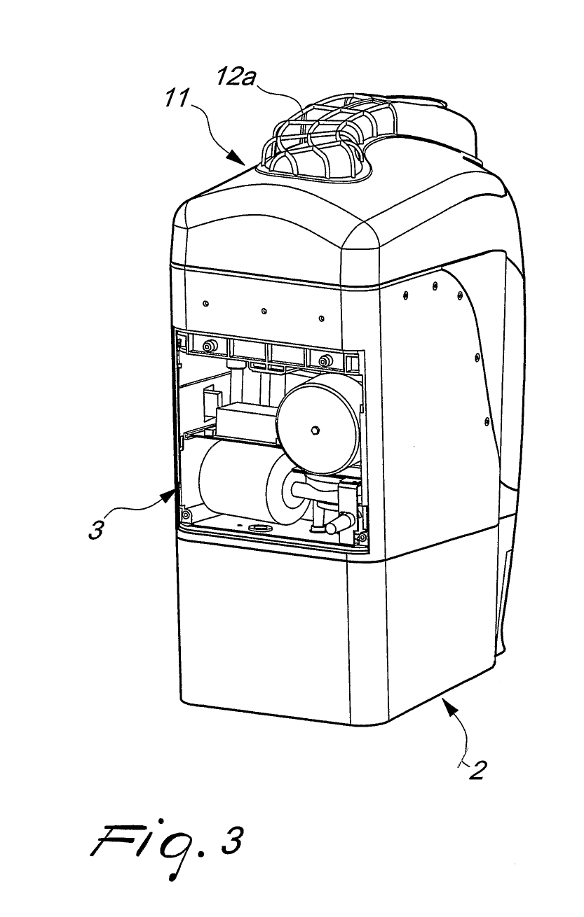

FIG. 4 is a perspective view of the machine of FIG. 1, with the upper lid in the removed configuration;

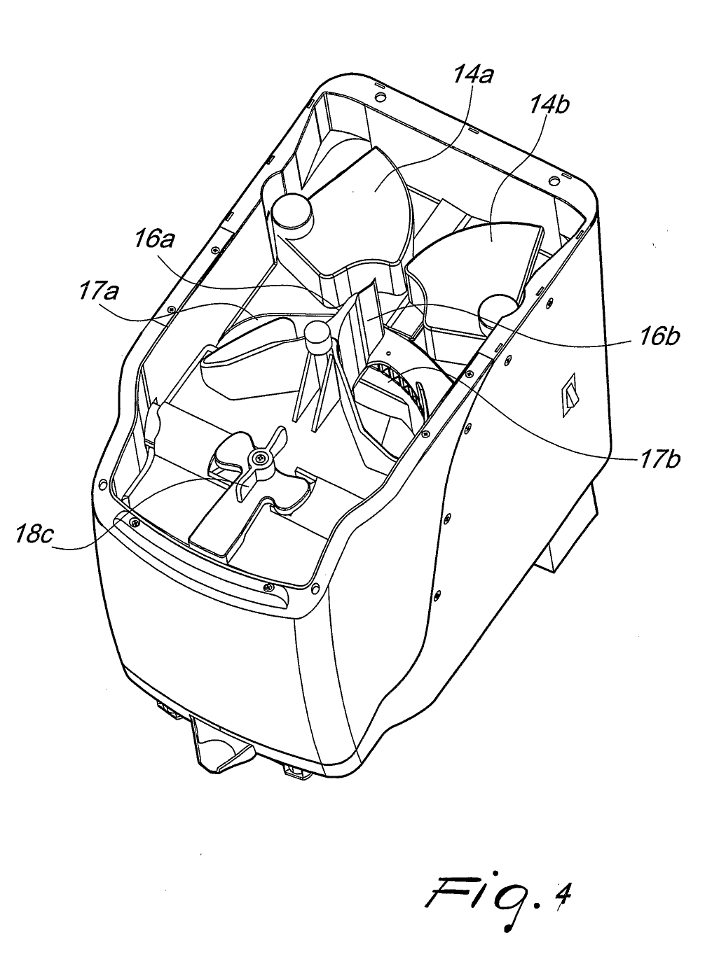

FIG. 5 is an enlarged-scale perspective view of the end of the chute of the transparent lid provided with a collar;

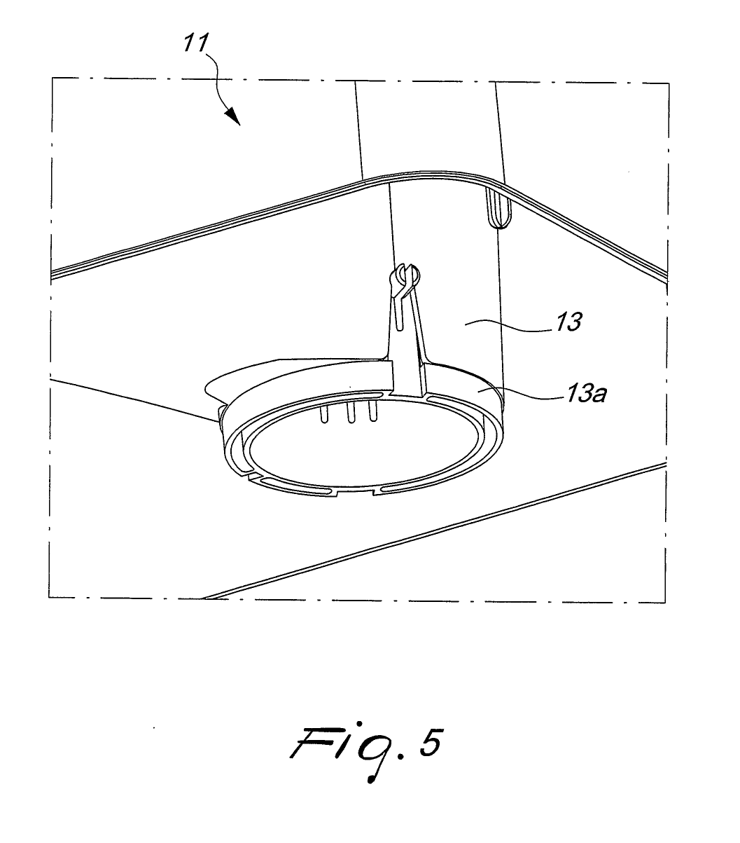

FIG. 6 is a top view of the juice extraction chamber;

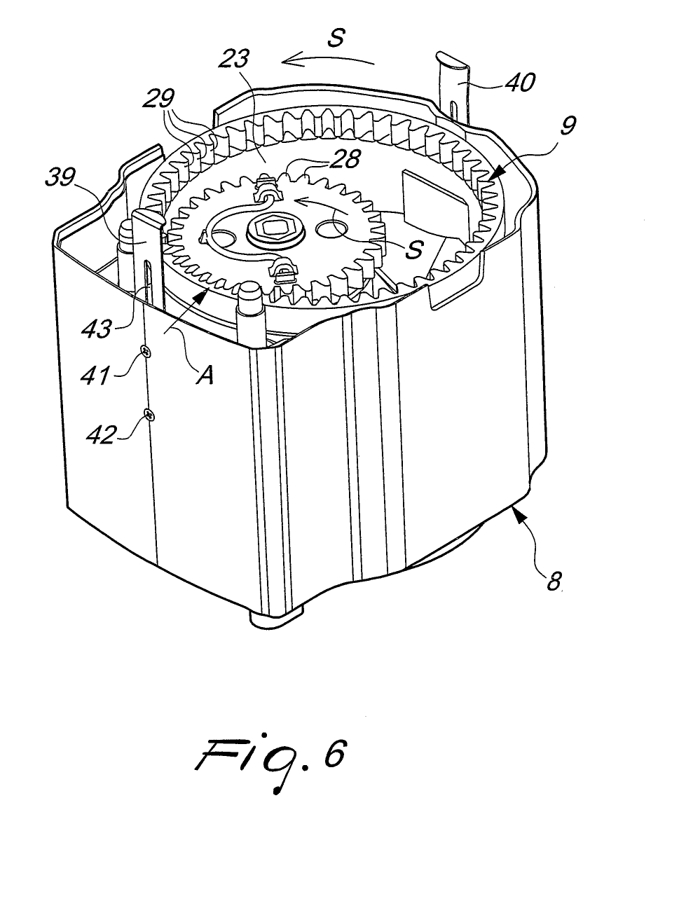

FIG. 7 is a top perspective view of the juice extraction drum;

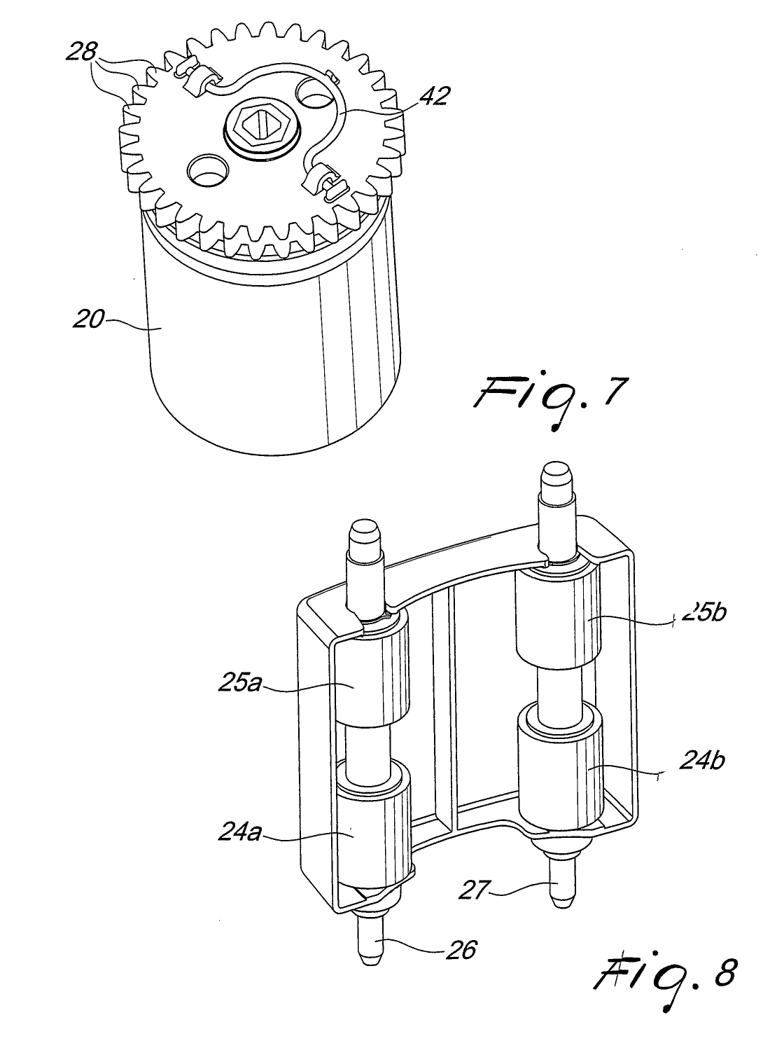

FIG. 8 is a perspective view of the supports of the outer drum;

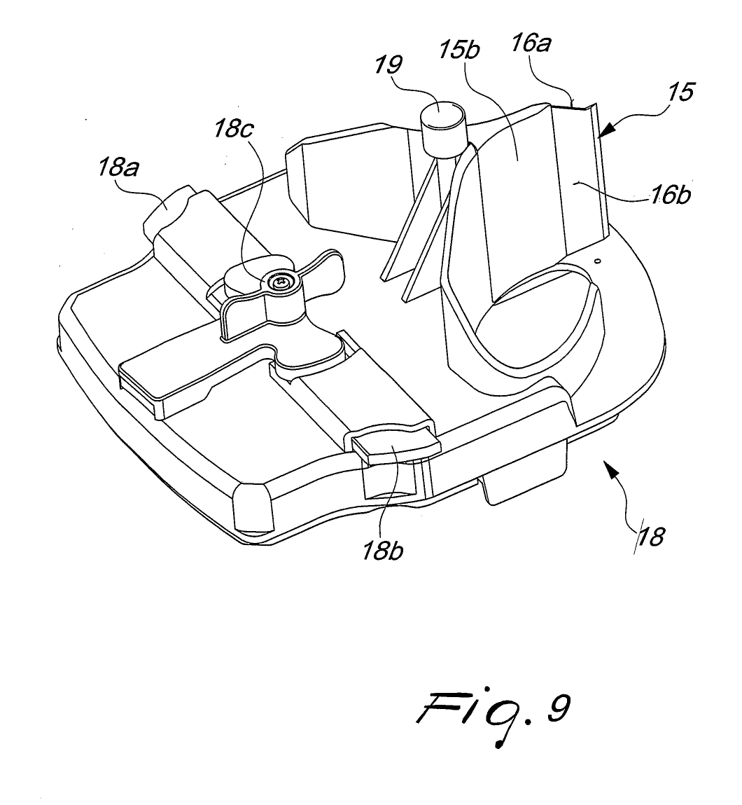

FIG. 9 is an enlarged-scale perspective view of the cutting lid;

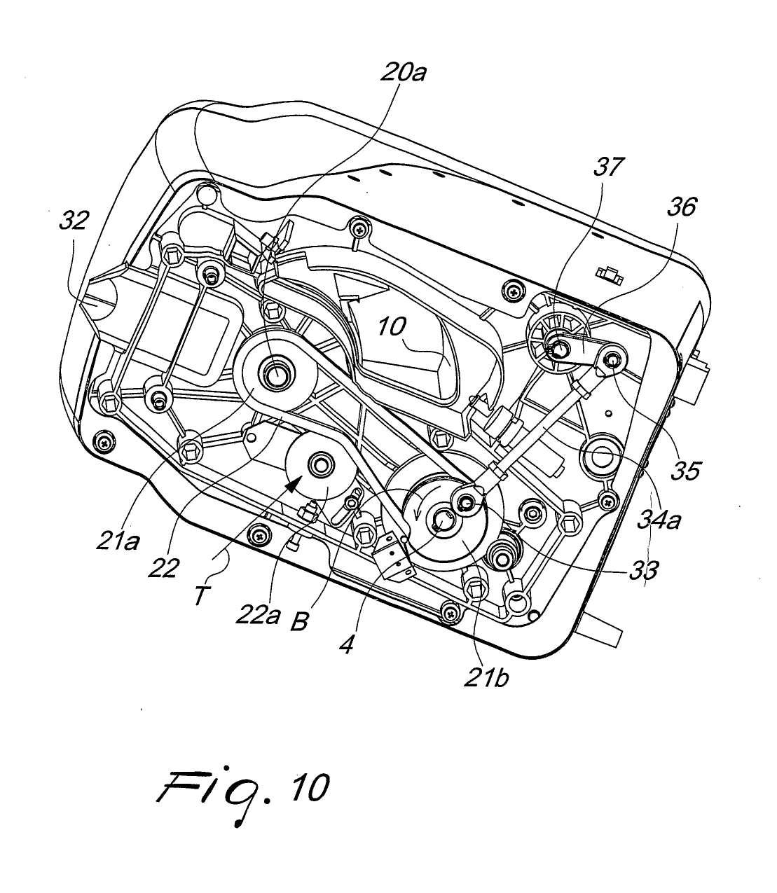

FIG. 10 is a bottom perspective view of the machine body at the level of the mechanisms for actuating the juice extraction drum;

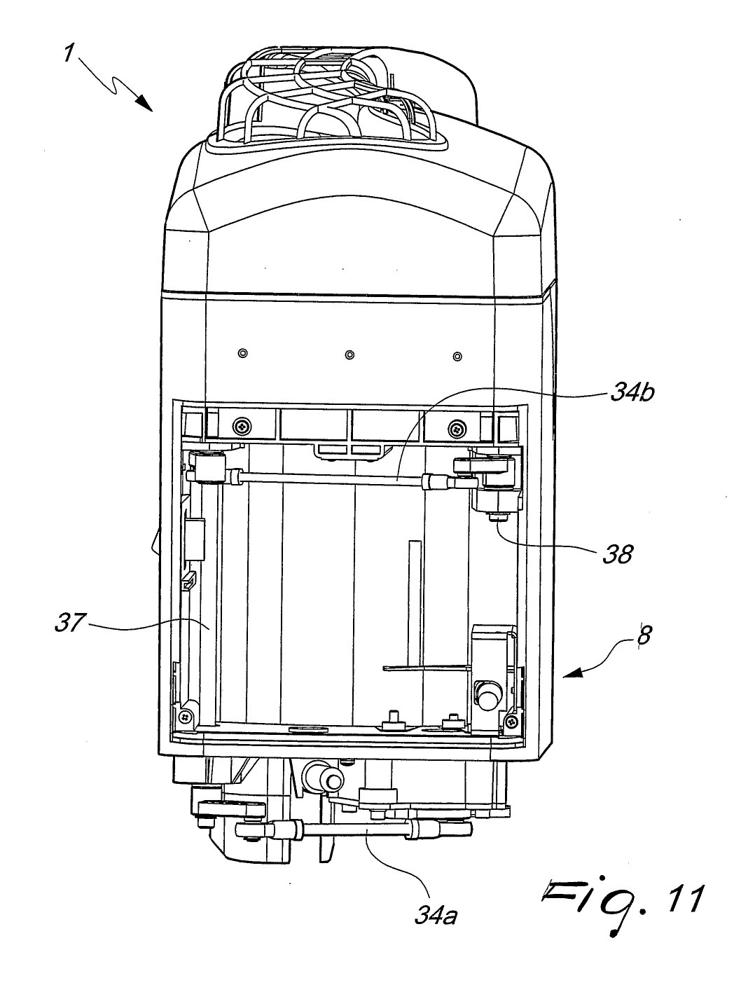

FIG. 11 is a rear view of the machine, with the gearmotor and the electrical system removed;

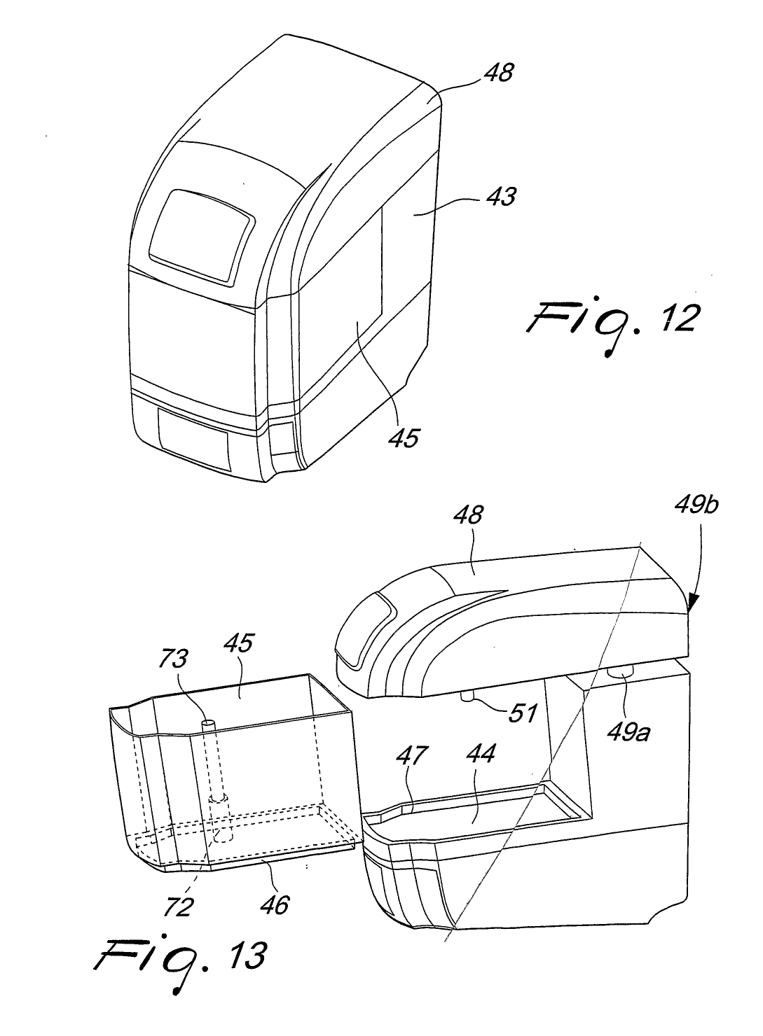

FIG. 12 is a general perspective view of an alternative embodiment of the machine according to the invention in the operating configuration;

FIG. 13 is a perspective view of the embodiment of FIG. 12 in the configuration for removing the juice extraction tank;

FIG. 14 is a perspective view of the embodiment of FIG. 12 of the machine, with the lower part shown in an exploded view;

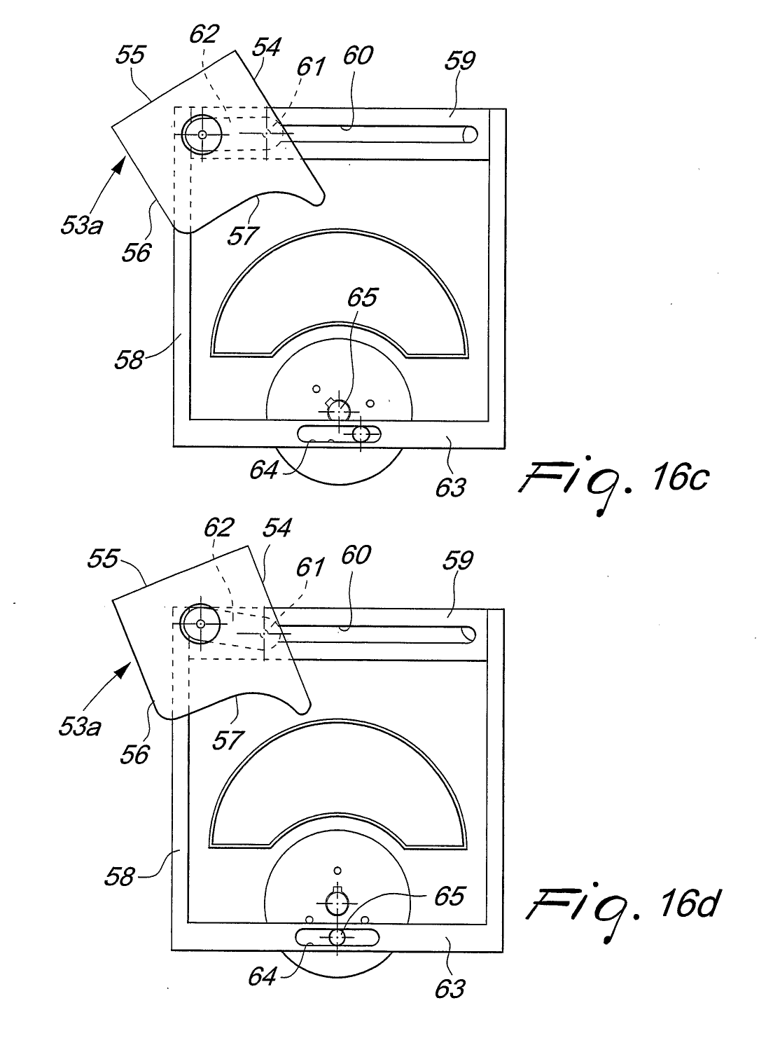

FIG. 15 is a schematic perspective view of the assembly for cutting oranges into two halves;

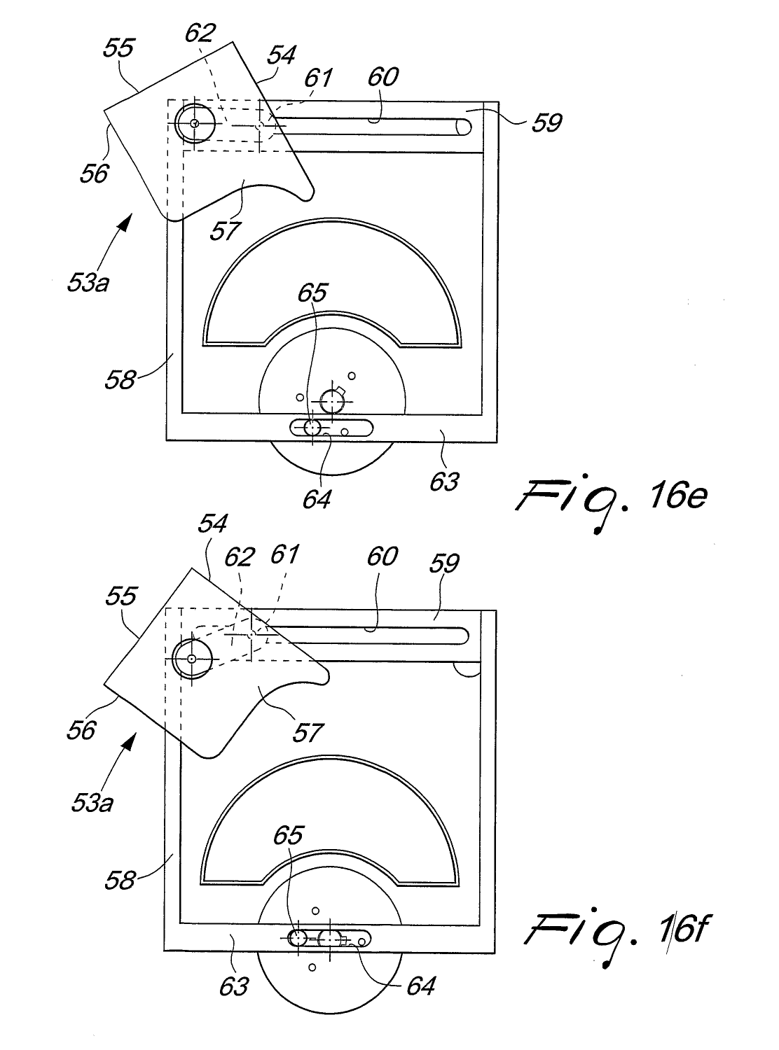

FIGS. 16a-16h are schematic plan views of the subsequent steps of the components of the cutting assembly of FIG. 15.

### WAYS OF CARRYING OUT THE INVENTION

With reference to the figures, the reference numeral 1 generally designates an automatic machine for citrus fruit juice extraction with functional elements allowing easier cleaning, according to the invention.

The machine 1 comprises a fixed supporting machine body or footing 2 which is box-shaped, is advantageously made of a material such as food-compatible plastics, and in which in a rear position there is a compartment 3 for a gearmotor assembly which has advantageously a transmissior shaft 4 which is inclined slightly forward with respect to the vertical: the compartment for containing the driving motor and the electrical/electronic equipment is provided with engagement teeth for engagement elements which can be actuated manually and are associated with a closure lid.

A large cutout 5 is open on the lower front part of the machine body 2, and a large tray 6 for collecting the juiced peels is mounted therein so that it can slide at the front, said tray having a profile of the front wall which blends with the profile of the front wall of the machine body 2, and having, on the base of the front wall, an extraction handle 7 which is provided by means of a recess within said wall: at the rear, the tray 6 can have a grip handle 7a to facilitate its transport once it has been extracted.

In an upper region and at the front, in the machine body, a juice extraction chamber is accommodated which comprises a tank 8 whose bottom is affected by a lateral opening 10 to allow the peels to fall.

A contoured transparent lid 11 with rounded corners is articulated by means of four centering pins along an upper lateral edge of the machine body, and a chute 12 having a substantially semicircular cross-section is provided therein for a row of fruits F1, F2, . . . FN and is slightly inclined downward; such chute has an inlet at the front and ends at the rear at a descent duct 13 for the subsequent fall of the individual fruits when they reach the position of the fruit Fl; in an upper region, the chute 12 can be protected by a cage 12a.

Safety microswitches are arranged at the lower edge of the lid and are designed to stop the machine immediately if the transparent upper lid opens accidentally, both from the front side and from the rear side.

Below the outlet of the descent duct 13 there are two paddle-type pushers 14a, 14b, which oscillate about vertical axes and are associated with means for rotary actuation in mutually opposite directions, which are adapted to move the pushers from a retracted configuration, which allows the fruit to be cut into two halves to fall into the descent duct, to a forward position, in which the top of the descent duct is blocked to prevent the descent of another fruit while the front faces of the pushers push simultaneously against the fruit and press it against a substantially vertical cutting blade 15 whose cutting edge is directed backward, said blade being centered between the pushers 14a, 14b which cut the fruit into two halves.

The blade 15 is extended by two contoured partitions 16a, 16b, which delimit two underlying symmetrical slots 17a, 17b.

The blade 15 is co-molded with a support 15b made of materials such as plastics, which in turn is mounted so that it can slide on an appropriately provided female dovetail guide provided on a cutting lid 18, and is fastened in the operating position by means of an upper knob 19 of a male threaded stem which mates with a threaded female metal insert which is fitted on the cutting lid.

The cutting lid is locked in the active position by means of two bolts 18a, 18b, which engage within respective slots formed in the inner side walls of the machine body, thus ensuring that the cutting lid cannot be lifted accidentally.

The bolts are retracted from the locking position by way of the manual rotation of an actuation knob 18c, which is keyed onto the pivot provided at the center of the cutting lid.

The actuation knob, of a type substantially known as cremone bolt, has in its lower part two pivots which are mounted so that they can slide within corresponding slots provided in the bolts. The rotation, performed manually, of the knob produces the simultaneous advancement or retraction of the two bolts, depending on the direction in which the knob is turned.

The knob 18c, after being turned so as to keep the bolts in the locking position, cannot accidentally move backward thanks to the presence of a suitable snap-acting elastic retention system.

The direction of the translational motion of the two bolts is insured by appropriately provided guides formed in the cutting lid, inside which the bolts slide.

The knob is provided with an arm, below which a safety sensor is fitted such that, if said knob is turned so as to release the bolts, the citrus fruit juice extraction machine cannot start.

A juice extraction assembly operates within the juice extraction chamber 8 and comprises a juice extraction and filtering drum 20, the lateral surface of which is perforated, or rather provided with fine perforations, in that it has a plurality of holes suitable for the passage of the extracted juice and to retain the solid or semisolid components of the fruits.

The drum 20 is coupled by way of quick-coupling means to the juice extraction shaft 20a, which is actuated and supported so that it can rotate on the base of the chamber 8.

A sprocket 21b is keyed to the lower end of the rotating shaft 4 and turns a pinion 21a by means of a connection provided by a chain 22 which is closed in a loop: the pinion 21b is actuated so that it can rotate by the gearmotor assembly 3 in the direction of the arrow B; the chain tensioning sprocket 22a acts on one of the portions of the chain 22 and is associated with elements for pushing in the direction and orientation T.

The juice extraction assembly provided within the juice extraction chamber comprises an additional drum 23 whose axis is slightly inclined with respect to the vertical and is supported so that it can rotate eccentrically outside the first drum 20 by two pairs of cylindrical supports, a lower one 24a, 24b and an upper one 25a, 25b, which are made advantageously of a material such as rubber or plastics with elastomer characteristics: the supports 24a, 25a and 24b, 25b are mounted so that they can rotate freely on respective shafts 26, 27 which are mutually spaced.

The drum 23 is subject to an adequate pressure in the direction of the arrow A applied by the elastic annular cylindrical supports which constitute the means for the elastic compression of the outer drum against the inner drum.

The action applied by the annular supports is adapted to press the inner surface of the drum 23 against the outer surface of the drum 20 at a juice extraction region which is located in the front region of the machine.

The supports 24a, 24b, 25a, 25b are designed to transmit the pressure and to keep the drum 23 guided.

The drums 20 and 23 are mutually associated kinenatically so as to rotate in the same direction with substantially identical targential speeds, at the directrix of contact: in this regard, respective radial sets of teeth, an outer set 28, which acts as a driving pinion, and an inner radial set 29, which acts as a driven pinion, are fixed to the upper edges of the drums 20 and 23.

The cut fruit halves pass through the slots 17a, 17b and rest with their cut faces against the surface of the inner drum: the simultaneous and matching rotation of the drums in the direction of the arrows S subsequently causes the fruit halves to pass through the gap that remains between the outer drum and the inner drum: said gap is variable, in that the outer drum can move slightly away from the inner drum by way of the deformation that the cylindrical supports made of a material with elastomer characteristics (rubber or the like) can undergo and also by way of the radial relative sliding of the teeth of the sets of teeth 28, 29.

The slots 17a, 17b are adapted to allow the two halves of the cut fruit to fall within the accessible volume formed between the drums 20 and 23, which precedes the juice extraction region.

The juice, through the perforated surface of the drum 20, falls into a descent duct which is formed within the thickness of the bottom of the chamber 9 and is conveniently conveyed toward the users: in particular, the juice, through a tubular channel, which passes through the bottom, reaches a dispensing spout 32 which conveys the juice into an optional container intended for users.

The peels left over from the two juiced fruit halves are expelled by gravity through an arc-like trapdoor which is provided so that it passes through the bottom of the tank and coincides with the corresponding opening 10 of the base of the chamber 9.

It should be specified that the base of the chamber 9 is not perfectly horizontal but has a suitable slope which is adapted to convey the juice by gravity toward the front regions of the machine, or at the channel-spout 32 for dispensing the extracted juice.

The machine has two different fruit feed systems, to be used depending on their dimensions, after calibration.

The generic fruit, for example an orange, is fed into the machine according to the invention through the chute 13, the outlet of which is adjacent to the blade 15.

A collar 13a is optionally fitted at the descent duct for dropping the fruits onto the chute and has such an outside diameter as to mate with the fall hole provided within the chute and an inside diameter which does not allow the passage of oranges whose diameter exceeds a preset range.

For oranges in the 60-70 mm range, there is a pair of paddle-type pushers 14a, 14b, which are substantially shaped like circular sectors whose height, with respect to the ideal fruit resting plane, is such as to not exceed the minimum possible height for oranges of this range, and which also have a radius of curvature which does not allow the passage, beyond a slight play, of oranges whose diameter exceeds the 60-70 mm range.

Likewise, for oranges having a diameter comprised between 70-80 mm range, there is a second pair of paddle-type pushers with characteristics of height and of radius of curvature which are similar to the ones described earlier but adapted this time to oranges of the 70-80 mm range.

For oranges whose diameter is comprised within the 70-80 mm range, the collar 13a is removed and the oranges pass directly through the hole provided at the end of the chute, said hole having such a diameter as to not allow the passage of oranges whose diameter exceeds said range.

Likewise, for oranges with a diameter comprised within the 70-80 mm range, there is a second pair of circular sectors which have height and radius of curvature characteristics which are similar to those described earlier but adapted this time to oranges of the 70-80 mm range

The two paddle-type pushers, which oscillate about vertical axes, are adapted to perform an alternating oscillating motion by way of a crank system which draws its motion from an eccentric element 33 which is rigidly coupled to the pinion 21b, a linkage 34 being particulated to said eccentric element and ending with a terminal joint 35 of a rod 36 which is pivoted to a vertical stem 37 onto which the paddle-type pusher 14b is keyed.

The paddle-type pusher 14a is keyed to a vertical stem 38, which is symmetrical to the stem 37 on a sectional plane which is central with respect to the machine: accordingly, two respective coplanar radial arms are mated on the elongated stem 37 and on the upper short stem 38, are oriented along parallel directions with opposite orientations, and have free ends pivoted to the ends of an upper linkage 34b, which intersects the line that connects the stems 37 and 38 so as to transmit to the stem 38 opposite and identical rotations with respect to the rotations of the stem 37.

The two paddle-type pushers oscillate with mutually opposite rotary synchronous motions about their own rotation axes, which are perpendicular to the bottom of the tank: synchronously, the two pushers oscillate and turn toward the rear part of the machine and allow the fruit to fall in the position in front of the edge of the blade, when the passage section obstructed previously by the upper planes of the two oscillating paddle-type pushers, opens completely.

Immediately thereafter, the motion of the pushers reverses and said pushers push the fruit against the edge of the blade, cutting and separating the citrus fruit into two symmetrical halves.

It is noted that the mechanical action of the drums, which in practice, due to their identical tangential speed, rotate inside each other without sliding contact, prevents wringing of the outer surface of the peels, minimizing the outflow of essential oils, which are very unpleasant, into the juice.

In the bottom of the tank there is an additional through hole, directly outside the descent duct, from which the essential oils provided in the peels can exit to be subsequently eliminated.

Cleaning is very simple, with respect to known citrus fruit juice extraction machines, because since the entire juice extraction assembly that comes into contact with the juices of the fruit is contained within the tank, and since said tank is easy to remove, the operator can always easily extract the entire tank, the outer and inner drums and the lid and empty them and wash them.

Extraction of the juice extraction chamber 8 together with all the components contained therein is made easy by two handles 39, 40, which extend vertically and are fitted so that they can slide vertically at the front and rear with respect to said chamber by using, for each handle, a pair of female threaded studs, which are fixed to the chamber by means of screws 41, 42 which pass through respective vertical slots 43 of the handles.

The handles are made to slide upward manually and move from a retracted inactive position to a grip position which protrudes upward from the tank.

An arc-like handle 42 is articulated to the upper end face of the drum 20 and facilitates grip for removing the drum for cleaning.

It is noted that the system for stopping the fruit obtained with the devices for pushing it against the edge of the blade do not hinder at all the extraction of the tank.

The juice extraction machine according to the invention is susceptible of numerous modifications and variations.

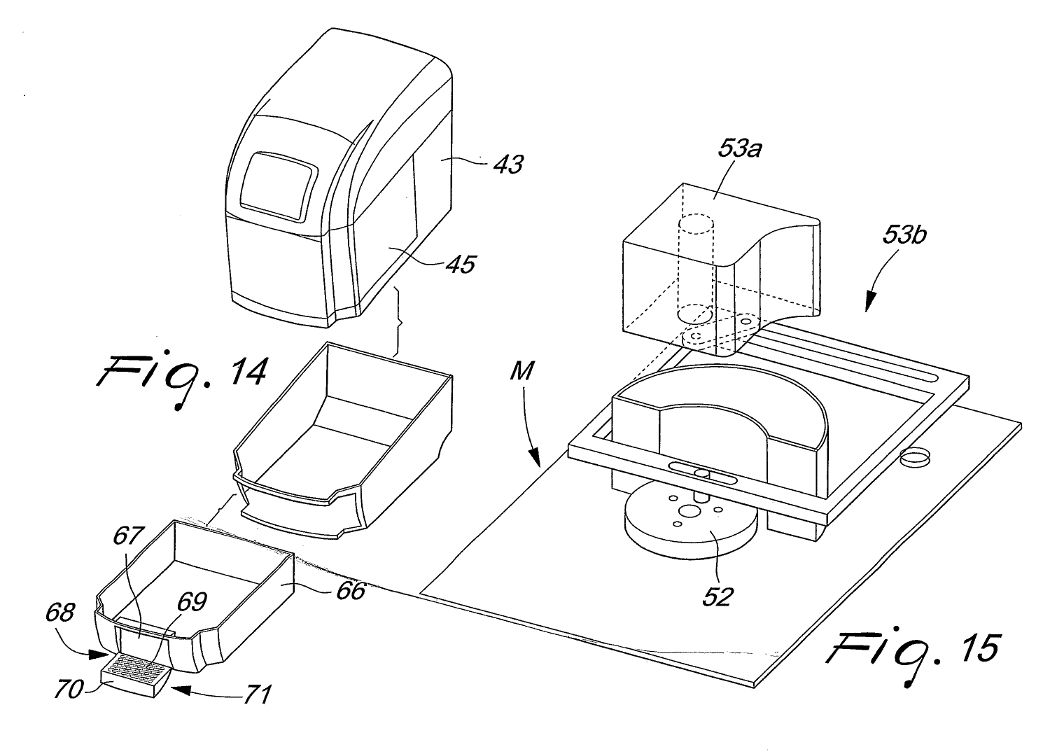

With reference to FIGS. 12 onward, modifications and variations which can be provided by way of example are described hereinafter.

One of the possible modifications is to move the motor, which in the preceding figures was contained at the rear of the machine body at an intermediate height.

In this embodiment, the machine body has at the rear, for some components of the machine, a box-like container 43 which rises from a platform 44 for supporting a juice extraction chamber 45, the base of which has a perimetric recess 46 which interlocks within an edge 47 of the platform.

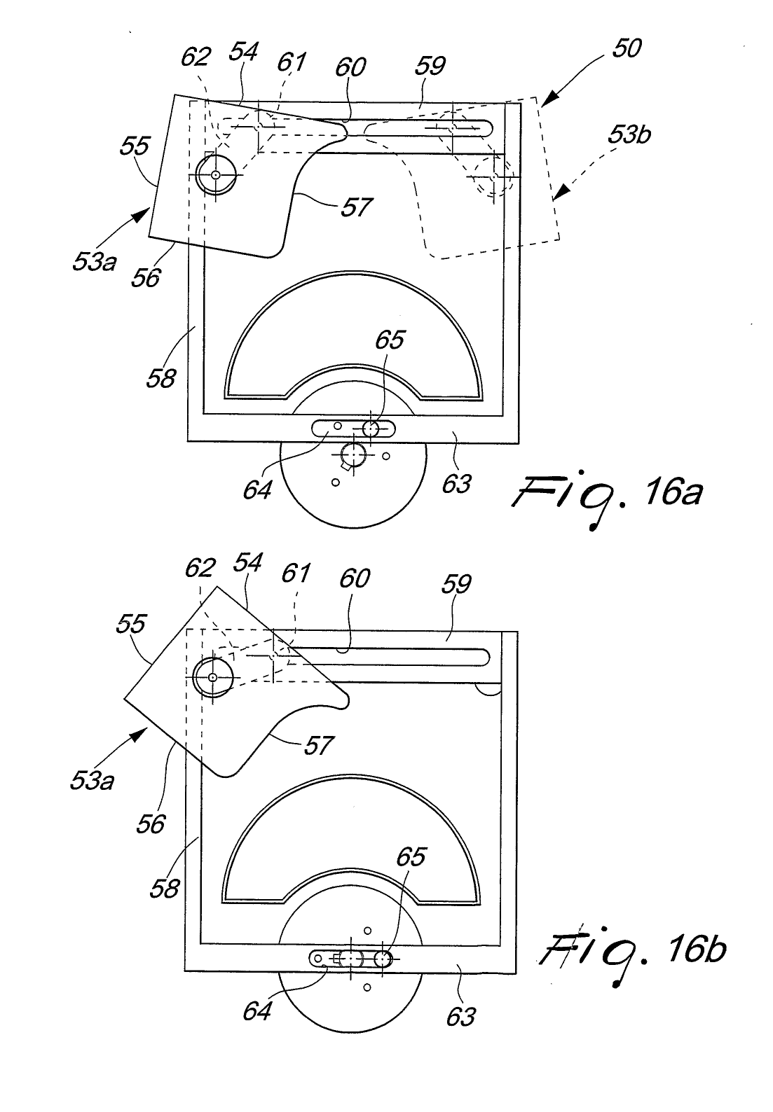

A flat upper housing 48 is superimposed on the box-like container and is mounted so that it can slide vertically along two lateral column-like guides 49a, 49b and can be positioned manually from a lowered configuration (see FIG. 12) for juice extraction and for cutting the oranges into two halves to a raised configuration (see FIG. 13) for removing and picking up the juice extraction chamber 45.

The housing 48 contains an assembly 50 for cutting in half each individual fruit, the actuation motor assembly arranged in the front region, designated by the reference letter M, and the mechanical connections of the motor to the internal juice extraction drum and to the cutting assembly.

The motor assembly is accommodated within the housing 48, which is located in the uppermost region of the machine body in a substantially forward position and has in output a toothed pinion 51, which when the housing is lowered meshes directly with the sprocket 28 which is rigidly coupled to the inner juice extraction drum 20.

A sprocket 52 for actuating the cutting assembly is also mounted within the housing and is engaged by a pinion which is actuated by said motor and can be the initial portion of the pinion 51 or can have a different axis.

In plan view, the paddle-type pushers 53a, 53b, along the three sides, the rear one 54, the lateral one 55 and the front one 56, are arranged substantially along the sides of a rectangle, while the other side 57 which acts on the fruit to be cut forms substantially a sinusoid or rather a reverse curve.

For the actuation of the paddle-type pushers there is a horizontal frame 58, which is substantially square and is mounted and guided so that it can slide in a forward direction within the housing along lateral guiding tracks or by means of slotted lateral rollers.

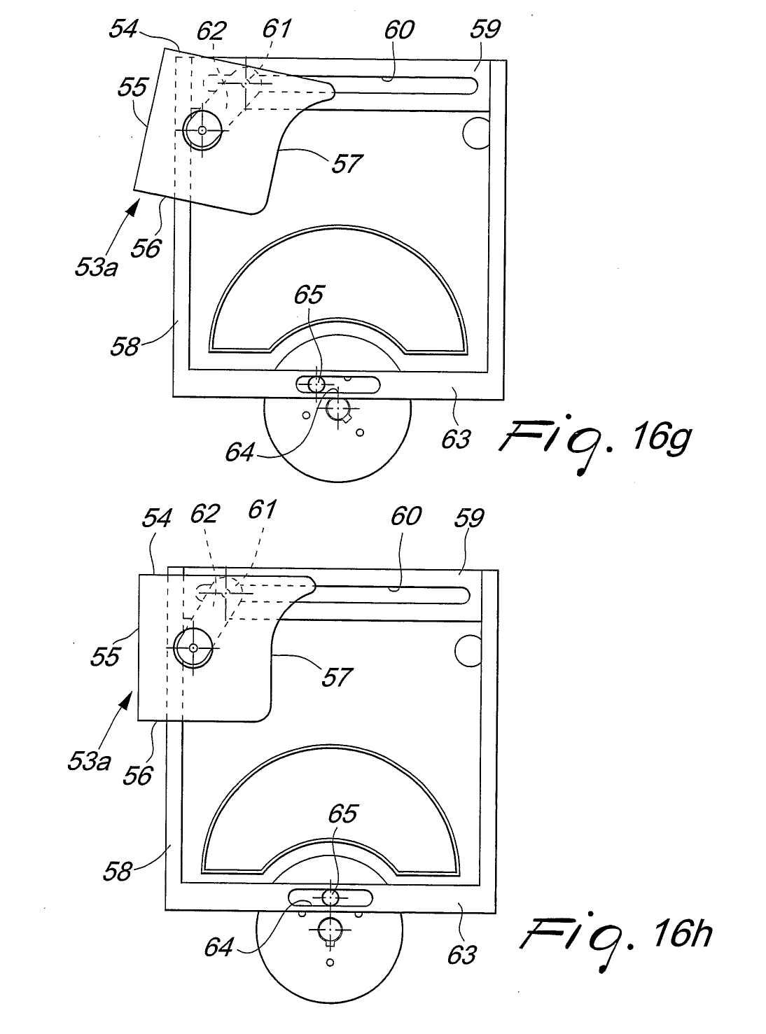

The rear side 59 of the square frame has a transverse slot 60 in which two respective pins 61 mate mirror-symmetrically, said pins protruding from corresponding arms 62 which are radially rigidly coupled to the paddle-type pushers: the forward and backward motion of the frame between a rear stroke limit and a front stroke limit causes a complete back-and-forth oscillation of the paddle-type pushers (see the sequence of FIGS. 16a-16h).

The front side 63 of the square frame is provided centrally with a transverse slot 64 in which an eccentric pin 65 of the sprocket 52 for actuating the cutting assembly is fitted so that it can slide; the rotation through 360° of said sprocket produces the advancement and then the complete retraction of the frame by an extent which is twice as long as the eccentricity of the pin 65 and corresponds to the complete cycle for cutting into two halves an orange and for returning to the configuration for the descent of the next fruit.

A tray 66 for collecting the peels has, in a front position, an opening 67 which has at its base means 68 for pivoting about a substantially horizontal and transverse axis for a tilt-down flap 69 which is provided perimetrically with a relief edge 70 which forms a tray 71 for supporting a cup for collecting the extracted juice.

Advantageously, a fixed vertical column 72 rises from the bottom of the removable tank 45 and a free shaft 73 is mounted on said column so that it can rotate with the interposition of rolling ball bearings; the outer extraction cylinder can be fitted onto the free shaft 73.

In a manner which is substantially identical to what has already been described earlier, the inner drum 20 has, in an upper region, a rigidly coupled sprocket 28 with an outer set of teeth which meshes with the sprocket with an inner set of teeth 29 of the external extraction drum 23, said drum being kept in axial alignment by the pairs of lower and upper elastic cylindrical supports 24a, 24b and 25a, 25b, which are mounted so that they can rotate freely in a front central position of the juice extraction tank 45.

The placement of the motor assembly in the front region of the housing designated by the reference letter M, the movements of the cutting paddles achieved with the frame which can slide at the front, the possibility to lift the housing by a short extent in order to be able to remove the juice extraction tank and the juice extraction drums for periodic cleaning interventions, the lower tilt-down flap for resting the cup, allow to reduce costs considerably and to improve hygienic conditions, avoiding contact with regions where sugary liquid drips.

It has thus been shown that the invention achieves the proposed aim and object.

The invention thus conceived is susceptible of numerous modifications and variations, all of which are within the scope of the appended claims.

All the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and the dimensions, may be any according to requirements without thereby abandoning the scope of the protection of the appended claims.

The disclosures in Italian Patent Application No. BO2006A000640 from which this application claims priority are incorporated herein by reference.

1-29. (canceled)

30. An automatic machine for citrus fruit juice extraction with functional elements allowing easier cleaning, said machine comprising a machine body, a motor assembly and a front juice extraction chamber lodging an inner juice extraction and filtration drum and an outer drum;
wherein the machine body is provided with quick-coupling means for the front juice extraction chamber,
wherein the front juice extraction chamber comprises a sort of tank inside which the outer drum is fitted so that it can rotate, and
wherein the juice extraction and filtration drum is fitted within said outer drum and is actuated rotatably concordantly with said outer drum at a short distance from its internal surface,
said juice extraction and filtration drum having a reduced diameter and a perforated surface, with an axis eccentric with respect to the extraction chamber, which is connectable with the motor assembly, and pressing means being provided for pressing said outer drum elastically against the inner drum.

31. The machine according to claim 30, wherein said inner drum has a rigidly coupled sprocket having a substantially equal sectional diameter and can be rotated by the motor assembly, while said outer drum has a rigidly coupled gear with internal teeth which meshes with the sprocket of the inner drum, and wherein said pressing means comprise at least one pair of cylindrical supports made of a material such as rubber.

32. The machine according to claim 30, wherein the motor assembly has a motor shaft which is directly coupled with said inner drum, and wherein said sort of tank has an eccentric hole on the bottom for the passage of said motor shaft.

33. The machine according to claim 32 wherein each fruit is divided into two fruit halves with a cut performed by pressing the fruit against a cutting blade by means of two paddle-type pushers which oscillate about vertical axes for actuation with a mutual opposite synchronous rotation, and wherein said paddle-type pushers are rigidly coupled to respective coplanar radial arms which are arranged in parallel directions with opposite orientations and whose free ends are pivoted to the ends of respective upper and lower linkages, which intersect a line that connects the axes of said pushers so as to transmit equal and mutually opposite rotations to said stems.

34. The machine according to claim 32, further comprising a cutting lid coupled with the front juice extraction chamber, wherein each fruit is divided into two fruit halves with a cut performed by pressing the fruit against a cutting blade arranged on the cutting lid, and wherein said quick-coupling means interlocks said cutting lid with the machine body.

35. The machine according to claim 34, wherein said quick-coupling means includes a bolt and guide coupling between the cutting lid and the machine body.

36. The machine according to claim 34, wherein said quick-coupling means includes two slots arranged laterally with respect to the machine body and two bolts fitted so that they can slide in corresponding guides of the cutting lid and a manually-operated knob for actuating said bolts, said slots being engageable by said respective bolts.

37. The machine according to claim 30, wherein said juice extraction chamber is provided with sliding handles at the front and at the rear to allow simultaneous extraction of the sort of tank and of all the components contained within said sort of tank.

38. The machine according to claim 30, wherein each fruit is divided into two fruit halves with a cut performed by pressing the fruit against a cutting blade by means of two paddle-type pushers which oscillate about vertical axes, and wherein said paddle-type pushers are connected to means for actuation with a mutual opposite synchronous rotation between a retracted configuration and forward configurations, and are arranged at an outlet of a descent feed duct for holding a single fruit in the retracted configuration and wherein, in the forward configurations, the pushers block the descent duct to prevent the descent of another fruit for a sequencing operation of said fruits through said outlet.

39. The machine according to claim 38, wherein said paddle-type pushers have a given height appropriate to a given range of dimensions of the fruit while, in plan view, said paddle-type pushers are delimited by front sectors rear sectors and wherein said front sectors have a radius of curvature for the pushing of the fruits, which is sized for fruits of said given range of dimensions.

40. The machine according to claim 38, wherein oranges having a diameter comprised within the 60÷70 mm range are fed by using a collar having a suitable diameter, which is mounted at the outlet of the feed duct by means of a snap-acting elastic interlocking system, and wherein said paddle-type pushers have a given height while, in plan view, said paddle-type pushers are delimited by front sectors having a given radius of curvature for the pushing of the oranges and wherein said height and said radius of curvature are sized appropriately so as to avoid the jamming of oranges of said range upstream of the cutting blade.

41. The machine according to claim 38, further comprising a transparent upper lid for lodging said descent duct and wherein microswitches are fitted at the transparent upper lid and are adapted to cause the immediate stopping of the machine if the lid is partially lifted.

42. The machine according to claim 30, wherein the machine body has, at the base, in a front region, a large opening for manual insertion of a tray for collecting the juiced peels, and wherein said tray is provided with a suitable front handle to facilitate its insertion and extraction and with an optional rear handle to facilitate its grip and transport.

43. The machine according to claim 30, further comprising electrical/electronic devices and a support made of a material such as metal plate for mounting the electrical/electronic devices, wherein said machine body defines a compartment for accommodating the motor assembly and the electrical/electronic devices within the rear part thereof, said compartment comprising engagement teeth for engagement elements which can be actuated manually and are associated with a closure lid and wherein guides for a drawer-like sliding of said support are provided on the inner side walls of the machine body.

44. The machine according to claim 30, wherein said outer drum is supported so that it can rotate eccentrically inside the sort of tank between two cylindrical pads, an upper one and a lower one made of a material such as rubber, wherein said juice extraction and filtration drum is centered on a cup for collecting the juices which is provided in the bottom of said sort of tank, and wherein said outer drum is subjected to pressure applied by said cylindrical pads which are adapted to press the internal surface of the outer drum against the outer surface of the extraction and filtration drum, which is perforated at a juice extraction region.

45. The machine according to claim 30, wherein each fruit is divided into two fruit halves with a cut performed by pressing the fruit against a cutting blade and wherein said cutting blade is arranged on a cutting lid coupled with the front juice extraction chamber, said cutting lid being provided with fixing means for said cutting blade which can be operated manually.

46. The machine according to claim 30, further providing at the base, in a front region, a large opening for manual insertion of a tray for collecting the juiced peels, and wherein said tray has, in a front position, an opening which has, at the base, pivoting means for a tilt-down flap which is provided perimetrically with an edge which forms a tray for a cup for the extracted juice.

47. An automatic machine for citrus fruit juice extraction with functional elements allowing easier cleaning, said machine comprising a machine body, an actuating motor assembly and a front juice extraction chamber lodging a juice extraction and filtration drum and an outer drum;
wherein the front juice extraction chamber comprises a sort of tank inside which the outer drum is fitted so that it can rotate, and
wherein the juice extraction and filtration drum is fitted within said outer drum and is actuated rotatably concordantly with said outer drum at a short distance from its internal surface,
said juice extraction and filtration drum having a reduced diameter and a perforated surface, with an axis eccentric with respect to the tank, and pressing means being provided for pressing said outer drum elastically against the juice extraction and filtration drum,
said machine further comprising a platform for supporting said juice extraction chamber and said machine body having at the rear, for some components of the machine, a box-like container which rises from said platform, and wherein the base of said box-like container interlocks within an edge of the platform,
an upper housing being superimposed on said box-like container and being mounted so that it can slide vertically along two lateral guides and can be positioned manually from a lowered juice extraction and cutting configuration to a raised configuration for removal and extraction of the juice extraction chamber,
said housing containing an assembly for cutting each individual fruit in half, the actuation motor assembly and mechanical connections of the motor assembly to said inner drum and to the cutting assembly.

48. The machine according to claim 47, wherein the juice extraction and filtration drum has a rigidly coupled sprocket having a substantially equal sectional diameter, while the outer drum has a rigidly coupled gear with internal teeth which meshes with the sprocket of the inner drum and wherein said motor assembly is accommodated within said housing located in the uppermost region of the machine body in a substantially forward position and has in output a toothed pinion which, when the housing is lowered, is adapted to mesh directly with the sprocket which is rigidly coupled to the juice extraction drum.

49. The machine according to claim 47, wherein said assembly for cutting includes a cutting blade and wherein the cut is performed by pressing against the cutting blade the fruit which is fixed by means of two paddle-type pushers which oscillate about vertical axes, and wherein, for the actuation of said paddle-type pushers, a horizontal frame which is mounted and guided so that it can slide in a forward direction within said housing, and wherein said frame has a slot in which two respective pins mate mirror-symmetrically, said pins protruding from corresponding arms which are rigidly coupled radially to said paddle-type pushers, the advancement and retraction of said frame between a rear stroke limit and a front stroke limit being adapted to cause a complete forward and return oscillation of said paddle-type pushers.

50. An automatic machine for citrus fruit juice extraction with functional elements allowing easier cleaning, said machine comprising a machine body, a motor assembly, and a front juice extraction chamber lodging an inner juice extraction and filtration drum and an outer drum;
wherein the front juice extraction chamber comprises a sort of tank inside which the outer drum is fitted so that it can rotate,
wherein the juice extraction and filtration drum is fitted within said outer drum and is actuated rotatably concordantly with said outer drum at a short distance from its internal surface;
said juice extraction and filtration drum having a reduced diameter and a perforated surface, with an eccentric axis which is connectable with the motor assembly, and pressing means being provided for pressing said outer drum elastically against the inner drum; and
wherein each fruit is divided into two fruit halves with a cut performed by pressing the fruit against a cutting blade which is fixed by means of two paddle-type pushers which oscillate about vertical axes between a retracted configuration and forward configurations, and
wherein said paddle-type pushers are arranged at an outlet of the descent feed duct and are connected to means for actuation with a mutual opposite synchronous rotation;
said paddle-type pushers having respective front faces for holding a single fruit in the retracted configuration while blocking the descent duct in the forward configurations to prevent the descent of another fruit while the front faces push against the fruit, for a sequencing operation of said fruits through said outlet.

51. The machine according to claim 50, wherein said paddle-type pushers are rigidly coupled to respective coplanar radial arms which are arranged in parallel directions with opposite orientations and whose free ends are pivoted to the ends of respective upper and lower linkages, which intersect a line that connects the axes of said pushers so as to transmit equal and mutually opposite rotations to the stems.

52. The machine according to claim 50, wherein said paddle-type pushers have a given height appropriate to a given range of dimensions of the fruit while, in plan view, said paddle-type pushers are delimited by front sectors rear sectors and wherein said front sectors have a radius of curvature for the pushing of the fruits, which is sized for fruits of said given range of dimensions.

53. The machine according to claim 50, wherein it comprises, for the actuation of said paddle-type pushers, a horizontal frame which is substantially square and is mounted and guided so that it can slide in a forward direction within said machine body and wherein said frame has a slot in which two respective pins mate mirror-symmetrically, said pins protruding from corresponding arms which are rigidly coupled radially to said paddle-type pushers, the advancement and retraction of said frame between a rear stroke limit and a front stroke limit being adapted to cause a complete forward and return oscillation of said paddle-type pushers.
